(19) United States
(12) Patent Application Publication
(10) Pub. No.: US 2025/0319928 A1
(43) Pub. Date: Oct. 16, 2025

(54) VEHICLE LOWER PART STRUCTURE

(71) Applicant: TOYOTA JIDOSHA KABUSHIKI KAISHA, Toyota-shi (JP)

(72) Inventors: Satoru ABE, Okazaki-shi (JP); Tetsuo NURUKI, Toyota-shi (JP); Seiji ARAKAWA, Nisshin-shi (JP); Kazusa ENDO, Toyota-shi (JP); Yuzuru SHIOTA, Nagoya-shi (JP)

(73) Assignee: TOYOTA JIDOSHA KABUSHIKI KAISHA, Toyota-shi (JP)

(21) Appl. No.: 18/999,402

(22) Filed: Dec. 23, 2024

(30) Foreign Application Priority Data
Apr. 10, 2024 (JP) 2024-063654

(51) Int. Cl. B62D 21/15; B60R 16/04; B62D 25/02; H01M 50/242; H01M 50/249; H01M 50/262

(52) U.S. Cl. CPC B62D 21/157; B60R 16/04; B62D 25/025; H01M 50/242; H01M 50/249; H01M 50/262; H01M 2220/20

(57) ABSTRACT

A vehicle lower part structure includes: a rocker located outward in a vehicle width direction of a vehicle cabin and extending in a vehicle front-rear direction; a shock absorbing portion composed of a plurality of energy absorbing portions arranged in the vehicle width direction in the rocker; and a battery disposed in a lower part of a vehicle. A part of the shock absorbing portion that is located outward in the vehicle width direction of a fastening portion has a lower rigidity than a part of the shock absorbing portion that is located inward in the vehicle width direction of the fastening portion, the fastening portion being a portion where the battery is fastened to the rocker.

### CROSS-REFERENCE TO RELATED APPLICATION

This application claims priority to Japanese Patent Application No. 2024-063654 filed on Apr. 10, 2024, incorporated herein by reference in its entirety.

### BACKGROUND

### 1. Technical Field

The present disclosure relates to vehicle lower part structures.

### 2. Description of Related Art

Japanese Unexamined Patent Application Publication No. 2013-133046 (JP 2013-133046 A) discloses a technique related to vehicle lower part structures in which a battery module is mounted. In this related art, a battery side frame provided outward in a vehicle width direction of the battery module is coupled to the lower side of a rocker.

### SUMMARY

In the above related art, there is a possibility that a side collision load (impact load) applied to the rocker upon a side-impact collision (hereinafter simply referred to as “side collision”) of a vehicle is applied to the battery via the battery side frame.

In view of the above, it is an object of the present disclosure to provide a vehicle lower part structure configured to reduce an impact load that is applied to a battery upon a side collision of a vehicle.

A vehicle lower part structure of the disclosure of claim 1 includes:
a rocker located outward in a vehicle width direction of a vehicle cabin and extending in a vehicle front-rear direction;
a shock absorbing portion composed of a plurality of energy absorbing portions arranged in the vehicle width direction in the rocker; and
a battery disposed in a lower part of a vehicle.
   A part of the shock absorbing portion that is located outward in the vehicle width direction of a fastening portion has a lower rigidity than a part of the shock absorbing portion that is located inward in the vehicle width direction of the fastening portion. The fastening portion is a portion where the battery is fastened to the rocker.

The vehicle lower part structure of the disclosure of claim 1 includes the rocker, the shock absorbing portion, and the battery. The rocker is located outward in the vehicle width direction of the vehicle cabin and extends in the vehicle front-rear direction. The shock absorbing portion is composed of the energy absorbing portions arranged in the vehicle width direction in the rocker. The battery is disposed in the lower part of the vehicle.

In the present disclosure, the part of the shock absorbing portion that is located outward in the vehicle width direction of the fastening portion, namely the portion where the battery is fastened to the rocker, has a lower rigidity than the part of the shock absorbing portion that is located inward in the vehicle width direction of the fastening portion. This configuration of the present disclosure can increase the amount of impact energy that is absorbed by the outer side in the vehicle width direction of the shock absorbing portion and reduce deformation of the inner side in the vehicle width direction of the impact absorbing portion upon a side collision of the vehicle.

The fastening portion where the battery is fastened to the rocker typically has a high rigidity. Therefore, the fastening portion can provide a sufficient reaction force against plastic deformation of the rocker and the shock absorbing portion upon a side collision of the vehicle, so that the part of the shock absorbing portion that is located outward in the vehicle width direction of the fastening portion is more likely to crush. Accordingly, it is possible to more effectively absorb the impact energy by the outer side in the vehicle width direction of the shock absorbing portion.

According to a vehicle lower part structure of the disclosure of claim 2, in the vehicle lower part structure of the disclosure of claim 1,
the shock absorbing portion may include an outer shock absorbing portion located in an outer side in the vehicle width direction of the rocker, and an inner shock absorbing portion located inward in the vehicle width direction of the outer shock absorbing portion.

In the vehicle lower part structure of the disclosure of claim 2, the shock absorbing portion includes the outer shock absorbing portion and the inner shock absorbing portion. The outer shock absorbing portion is located in the outer side in the vehicle width direction of the rocker. The inner shock absorbing portion is located inward in the vehicle width direction of the outer shock absorbing portion.

The outer shock absorbing portion has a lower rigidity than the inner shock absorbing portion. This allows the outer shock absorbing portion to absorb a greater amount of impact energy than the inner shock absorbing portion upon a side collision of the vehicle. The inner shock absorbing portion has a higher rigidity than the outer shock absorbing portion. This configuration can reduce deformation of the inner shock absorbing portion upon a side collision of the vehicle, and can thus protect the inside of the vehicle cabin and the battery that are located inward of a pair of right and left rockers.

According to a vehicle lower part structure of the disclosure of claim 3, in the vehicle lower part structure of the disclosure of claim 2, the outer shock absorbing portion and the inner shock absorbing portion may be provided as a single-piece member.

In the vehicle lower part structure of the disclosure of claim 3, the outer shock absorbing portion and the inner shock absorbing portion are provided as a single-piece member. The present disclosure includes a case where the outer shock absorbing portion and the inner shock absorbing portion are integrally molded. In this case, the number of components can be reduced.

According to a vehicle lower part structure of the disclosure of claim 4, in the vehicle lower part structure of the disclosure of claim 1,
the shock absorbing portion may be composed of a plurality of members having different rigidities, and the members may be integrated by being coupled to each other.

In the vehicle lower part structure of the disclosure of claim 4, the shock absorbing portion is composed of a plurality of members having different rigidities, and the members may be integrated by being coupled to each other. This improves design flexibility. As used herein, the term “coupling” includes fitting, welding, deposition welding, etc.

According to a vehicle lower part structure of the disclosure of claim 5, in the vehicle lower part structure of the disclosure of claim 1,
the fastening portion may be located on a lower wall of the rocker.

In the vehicle lower part structure of the disclosure of claim 5, the fastening portion is located on the lower wall of the rocker. This can reduce stress concentration on a battery pack via the fastening portion upon a side collision of the vehicle compared with a case where the fastening portion is located on a side wall of the rocker.

As described above, the vehicle lower part structure according to the present disclosure can reduce an impact load that is applied to the battery upon a side collision of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an enlarged cross-sectional view of a main part of a vehicle to which a vehicle lower part structure according to a first embodiment is applied, the main part being enlarged; and

FIG. 2 is an enlarged cross-sectional view of a main part showing a first modification in a vehicle to which the vehicle lower part structure according to the first embodiment is applied.

### DETAILED DESCRIPTION OF EMBODIMENTS

A vehicle lower part structure according to an embodiment of the present disclosure will be described with reference to the drawings. Note that the arrow UP and the arrow RH indicated as appropriate in the drawings indicate the upward direction and the rightward direction of the vehicle to which the vehicle lower part structure according to the present embodiment is applied. Hereinafter, when the description is made simply using terms indicating directions i.e., forward and rearward, right and left, and upward and downward, these means forward and rearward in the vehicle front-rear direction, right and left in the vehicle right-left direction (vehicle width direction), and upward and downward in the vehicle up-down direction unless otherwise specified. In addition, in the drawings, some members and some reference numerals may be omitted from the drawings in order to make the drawings easy to see.

### Configuration of Vehicle Lower Part Structure

First, a configuration of a vehicle lower part structure according to an embodiment of the present disclosure will be described.

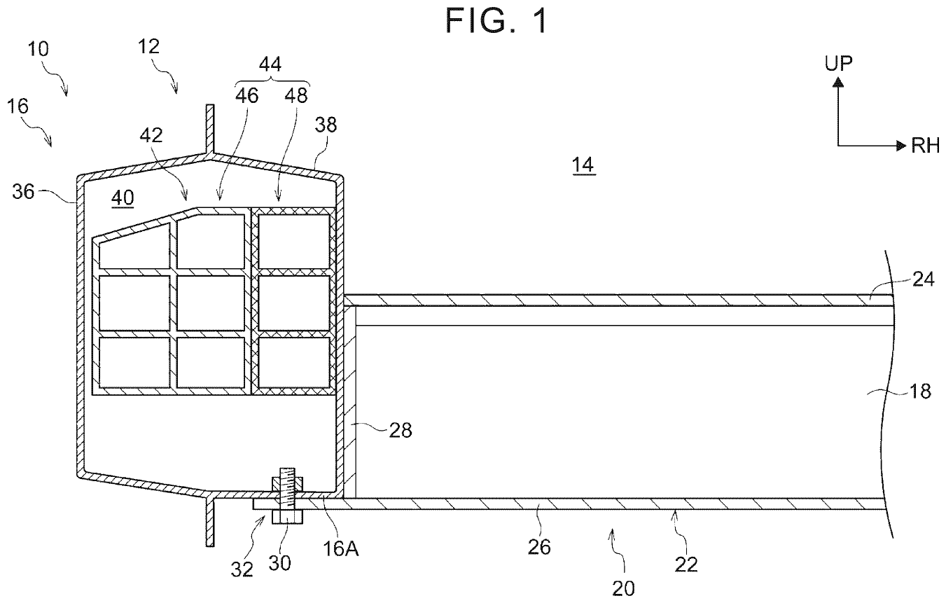

As shown in FIG. 1, the vehicle (vehicle body) 12 to which the vehicle lower part structure 10 according to the embodiment of the present disclosure is applied includes a pair of left and right rockers 16 each constituting a vehicle skeleton and extending along the vehicle front-rear direction at both end portions in the vehicle width direction of the vehicle cabin 14. Although not shown, a front cross member (not shown) is provided at a front end of the pair of left and right rockers 16 along the vehicle width direction, and a rear cross member (not shown) is provided at a rear end of the pair of left and right rockers 16 along the vehicle width direction.

In addition, the vehicles 12 according to the present embodiment are battery electric vehicle (BEV) traveling by using a driving force of an electric motor (not shown). A battery pack (battery) 20 in which a plurality of battery cells 18 that supply electric power for driving to the electric motor is accommodated is provided in a lower part of the vehicle 12. The vehicles 12 may be plug-in hybrid electric vehicle (PHEV), fuel cell electric vehicle (FCEV), or the like.

The battery pack 20 is made of, for example, a light metal such as an aluminum alloy, and includes a box-shaped battery case 22 having a rectangular shape that is long in a vehicle front-rear direction as viewed in plan and having an upper side as an opening. The battery case 22 may be made of a resin member such as carbon-fiber-reinforced plastic (CFRP) or glass-fiber-reinforced plastic (GFRP).

The battery case 22 is closed by, for example, a cover 24 having a rectangular plate shape in a plan view in a state in which a plurality of battery cells 18 are accommodated. The cover 24 is made of, for example, a light metal such as an aluminum alloy, and has a plate shape in which the vertical direction of the vehicle is a plate thickness direction, and is integrated with the battery case 22 by welding or the like. The cover 24 constitutes a floor constituting a floor portion in the vehicle cabin 14, and a floor cross member is disposed on the cover 24 along the vehicle width direction so as to be bridged between a pair of left and right rockers 16 (not shown).

On the other hand, the battery case 22 includes, for example, a bottom wall 26 and a side wall 28 erected from an outer edge of the bottom wall 26. The bottom wall 26 extends outward beyond the side wall 28 in the vehicle width direction, and is fastened to the lower wall 16A of the rocker 16 via a fastening portion 32 such as a bolt 30. Accordingly, the battery case 22 is supported by the rocker 16.

In the present embodiment, the rocker 16 includes the outer portion 36 and the inner portion 38, and the closed section portion 40 is formed by the outer portion 36 and the inner portion 38. An EA portion (shock absorbing portion) 42 is disposed in the closed section portion 40.

The closed section portion 40 has, for example, a substantially hexagonal cross-sectional shape when cut along the vehicle width direction and the vehicle vertical direction, and is formed so that the dimension in the vehicle vertical direction is longer than the dimension in the vehicle width direction. The cross-sectional shape of the closed section portion 40 is not particularly limited.

Further, in FIG. 1, the rocker 16 is illustrated in a state in which the outer portion 36 and the inner portion 38 are integrally molded, but it is needless to say that the outer portion 36 and the inner portion 38 may be integrated by being formed of separate members and joined to each other. Further, EA portion 42 may be coupled to the rocker 16 via a coupling portion (not shown), such as a bolt, or may be integrally molded with the rocker 16 by extrusion molding etc.

In the present embodiment, EA portion 42 is constituted by a plurality of energy absorbing portions 44 each having a closed cross-sectional shape having a substantially rectangular cross-sectional shape when cut along the vehicle widthwise direction and the vehicle vertical direction. Further, in the present embodiment, the substantially central portion of EA portion 42 is substantially at the same height as the position of the cover 24.

That is, the upper side of EA portion 42 overlaps the inside of the vehicle cabin 14 when viewed from the vehicle side, and the lower side of EA portion 42 overlaps the upper part of the battery pack 20 when viewed from the vehicle side. When a floor cross member is provided in the vehicle cabin 14, the upper portion of EA portion 42 overlaps with the floor cross member in a side view of the vehicle.

Here, in the present embodiment, EA portion 42 is made of metal such as iron or aluminum alloy, or carbon-fiber reinforced plastic (CFRP) or the like. EA portion 42 includes a low-rigidity portion (outer shock absorbing portion) 46 provided on the outer side in the vehicle width direction and a high-rigidity portion (inner shock absorbing portion) 48 provided on the inner side in the vehicle width direction. Here, for the sake of clarity, the low rigidity portion 46 is indicated by hatching, and the high rigidity portion 48 is indicated by cross hatching.

In the present embodiment, for example, the low-rigidity portion 46 is formed to have a thickness smaller than that of the high-rigidity portion 48, and has a lower rigidity than that of the high-rigidity portion 48. Here, the “low rigidity” is referred to for convenience by comparing with the “high rigidity portion”, and the rigidity as the original function of EA portion 42 is secured.

In addition, the low-rigidity portion 46 and the high-rigidity portion 48 may be integrally molded or may be separately formed. When the low-rigidity portion 46 and the high-rigidity portion 48 are separately formed, the low-rigidity portion 46 and the high-rigidity portion 48 are integrated (provided as a single-piece member) by coupling by welding, deposition welding, fastening, fitting, etc. according to the material.

Further, in the present embodiment, the low-rigidity portion 46 is composed of two rows×three, and the high-rigidity portion 48 is composed of one row×three. A fastening portion 32 is provided on the lower side of the high rigidity portion 48. That is, in the present embodiment, the low rigidity portion 46 is provided at a portion located outside the fastening portion 32 in the vehicle width direction, and the high rigidity portion 48 is provided at a portion located inside the fastening portion 32 in the vehicle width direction. Operation and effects of vehicle lower part structure

Next, the operation and effects of the vehicle lower part structure according to the present embodiment will be described.

As shown in FIG. 1, in the present embodiment, a rocker 16, a EA portion 42, and a battery pack 20 are provided in the vehicle lower part structure 10. The rocker 16 extends in the vehicle front-rear direction on the outer side in the vehicle width direction of the vehicle cabin 14, and EA portion 42 is constituted by a plurality of energy absorbing portions 44 arranged in the rocker 16 along the vehicle width direction. In addition, the battery pack 20 is disposed at a lower part of the vehicle.

Here, in the present embodiment, a portion of EA portion 42 located on the outer side in the vehicle width direction than the fastening portion 32 to which the battery pack 20 is fastened with respect to the rocker 16 has lower rigidity than a portion located on the inner side in the vehicle width direction than the fastening portion 32. Thus, in the present embodiment, upon a side collision of the vehicle 12, the absorbed quantity of the impact energy can be increased on the outer side in the vehicle width direction of EA portion 42, and deformation can be suppressed on the inner side in the vehicle width direction of EA portion 42.

Generally, since the fastening portion 32 of the battery pack 20 has high rigidity, a sufficient reaction force against plastic deformation of the rocker 16 and EA portion 42 can be obtained by the fastening portion 32 upon a side collision of the vehicle 12. Therefore, the part of the EA portion 42 that is located outward in the vehicle width direction of the fastening portion 32 is more likely to crush upon a side collision of the vehicle 12, and the impact energy can be absorbed more effectively. As a result, in the present embodiment, it is possible to reduce the impact load that is applied to the battery pack 20 upon a side collision of the vehicle 12.

The configuration of EA unit 42 according to the present embodiment will be specifically described. EA portion 42 is constituted by a plurality of energy absorbing portions 44 having a closed cross-sectional shape that forms a substantially rectangular shape. EA portion 42 changes the thickness of the energy absorbing portion 44. EA portion 42 includes a low-rigidity portion 46 and a high-rigidity portion 48. The low-rigidity portion 46 having a relatively small plate thickness is provided on the outer side in the vehicle width direction, and the high-rigidity portion 48 having a relatively large plate thickness is provided on the inner side in the vehicle width direction.

Since the low-rigidity portion 46 has a lower rigidity than the high-rigidity portion 48, the amount of absorbed impact energy can be increased more than the high-rigidity portion 48. The high-rigidity portion 48 has higher rigidity than the low-rigidity portion 46. Therefore, in the present embodiment, upon a side collision of the vehicle 12, deformation can be reduced, and thus the inside of the vehicle cabin 14 and the battery pack 20 can be protected.

In the present embodiment, since the rigidity is changed between the low rigidity portion 46 and the high rigidity portion 48 by changing the plate thickness, the low rigidity portion 46 and the high rigidity portion 48 can be integrally molded. As described above, by integrally molding the low-rigidity portion 46 and the high-rigidity portion 48, the number of parts can be reduced.

Further, in the present embodiment, the fastening portion 32 is provided on the lower wall 16A of the rocker 16. As a result, although not shown, the gap between the rocker 16 and the battery pack 20 can be made smaller than in the case where the fastening portion 32 is provided in the side wall of the rocker 16. That is, in the present embodiment, the battery pack 20 can be made large by reducing the gap, and the battery capacity can be increased accordingly.

Further, as a comparative example, although not shown, in a case where the fastening portion 32 is provided between the rocker 16 and the battery pack 20, there is a possibility that stress is concentrated on the battery pack 20 via the fastening portion 32 upon a side collision of the vehicle 12. On the other hand, in the present embodiment, since the battery pack 20 is accommodated between the left and right rockers 16, it is possible to suppress the occurrence of stress concentration occurring in the battery pack via the fastening portion 32 upon a side collision of the vehicle 12. That is, in the present embodiment, it is possible to protect the battery pack 20 upon a side collision of the vehicle 12.

Further, in the present embodiment, the substantially central portion of EA portion 42 is substantially at the same height as the position of the cover 24. That is, the upper side of EA portion 42 overlaps with the inside of the vehicle cabin 14 when viewed from the vehicle side, and the lower side of EA portion 42 overlaps with the battery pack 20 when viewed from the vehicle side. Therefore, in the present embodiment, it is possible to protect the inside of the vehicle cabin 14 and the battery pack 20 upon a side collision of the vehicle 12.

Incidentally, in the present embodiment, the rigidity of the low rigidity portion 46 and the high rigidity portion 48 is changed by changing the plate thickness in EA portion 42, but the rigidity of the low rigidity portion 46 only needs to be lower than that of the high rigidity portion 48, and is not limited thereto. Therefore, it is not necessary to integrally mold the low-rigidity portion 46 and the high-rigidity portion 48. That is, the low-rigidity portion 46 and the high-rigidity portion 48 may be formed separately.

For example, when the low-rigidity portion 46 and the high-rigidity portion 48 are separately formed of materials having different rigidities, the low-rigidity portion 46 and the high-rigidity portion 48 are integrated by being coupled to each other by welding, deposition welding, fastening, fitting, etc. according to the material. As described above, the degree of freedom in design is improved as compared with the case where the low-rigidity portion 46 and the high-rigidity portion 48 are separately formed to integrally mold both portions.

In addition, in order to improve the rigidity of the high-rigidity portion 48 more than that of the low-rigidity portion 46, a reinforcing portion or a reinforcing member such as a brace may be used in the energy absorbing portion 44. Further, the shape of the energy absorbing portion 44 itself is not limited to a substantially rectangular shape, and may be a triangular shape or a hexagonal shape. Modification of the present embodiment

In the above-described embodiment, as illustrated in FIG. 1, the energy absorbing portions 44 of EA portions 42 are arranged in three rows x three along the vehicle vertical direction and the vehicle widthwise direction. The upper side of EA portion 42 overlaps the inside of the vehicle cabin 14 when viewed from the vehicle side, and the lower side of EA portion 42 overlaps the upper portion of the battery pack 20 when viewed from the vehicle side. However, the arrangement of EA portions 42 is not limited thereto.

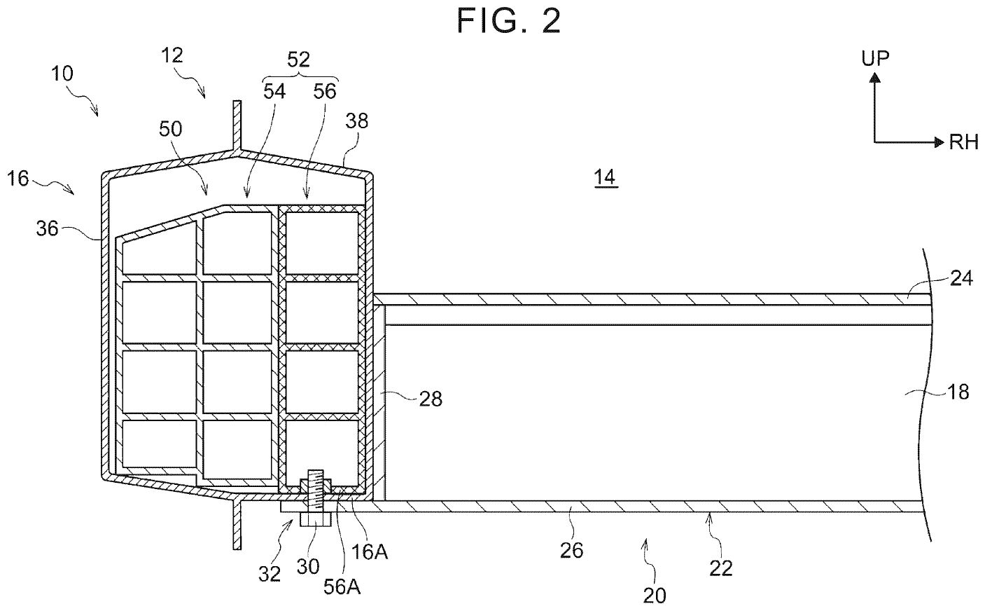

For example, in the modification, as shown in FIG. 2, the energy absorbing portion 52 of EA portion 50 is arranged in three rows x four along the vehicle vertical direction and the vehicle widthwise direction, the low-rigidity portion 54 is composed of two rows x four, and the high-rigidity portion 56 is composed of one row x four. The low-rigidity portion 54 is provided outside the fastening portion 32 in the vehicle width direction, and the high-rigidity portion 56 is provided inside the vehicle width direction. The lower wall 56A of the high-rigidity portion 56 is fastened together with the bottom wall 26 of the battery case 22 together with the lower wall 16A of the rocker 16.

That is, in the modification, the upper side of EA portion 50 overlaps the inside of the vehicle cabin 14 in the vehicle side view, and the lower side of EA portion 50 overlaps the substantially entire area of the battery pack 20 in the vehicle vertical direction in the vehicle side view. In a modification, the lower wall 56A of the high-rigidity portion 56 is fastened to the lower wall 16A of the rocker 16. Therefore, when the rocker 16 and EA portion 50 are deformed upon a side collision of the vehicle 12, EA portion 50 can be prevented from moving upward of the rocker 16, and EA portion 50 can be maintained overlapping with the battery pack 20 when viewed from the side of the vehicle.

In the modification, the lower wall 56A of the high-rigidity portion 56 is fastened together with the lower wall 16A of the rocker 16 to the bottom wall 26 of the battery case 22. Therefore, in the modification, the impact load applied to the high-rigidity portion 56 can be transmitted to the opposite rocker through the lower wall 56A of the high-rigidity portion 56 and the bottom wall 26 of the battery case 22, and load distribution in the impact load can be achieved.

### ADDITIONAL REMARKS

Note that the vehicle lower part structure according to the present disclosure may be formed by appropriately combining the following configurations.

### Configuration 1

A rocker extending in a vehicle front-rear direction on an outer side in a vehicle width direction, a shock absorbing portion composed of a plurality of energy absorbing portions arranged in a vehicle width direction in the rocker, and a battery arranged in a lower part of a vehicle are provided, and the shock absorbing portion has lower rigidity than an inner side in a vehicle width direction on an outer side in a vehicle width direction than a fastening portion to which the battery is fastened to the rocker.

### Configuration 2

The shock absorbing portion includes an outer shock absorbing portion provided on an outer side in the vehicle width direction and an inner shock absorbing portion provided on an inner side in the vehicle width direction.

### Configuration 3

The outer shock absorbing portion and the inner shock absorbing portion are integrally molded.

### Configuration 4

The shock absorbing portion is formed of a plurality of members having different rigidities, and is integrated by coupling.

### Configuration 5

The fastening portion is provided on a lower wall of the rocker.

In addition, the present disclosure can be implemented with various modifications without departing from the scope of the disclosure. Further, it goes without saying that the scope of rights of the present disclosure is not limited to the above-described embodiment.

What is claimed is:

1. A vehicle lower part structure, comprising:
a rocker located outward in a vehicle width direction of a vehicle cabin and extending in a vehicle front-rear direction;
a shock absorbing portion composed of a plurality of energy absorbing portions arranged in the vehicle width direction in the rocker; and
a battery disposed in a lower part of a vehicle, wherein a part of the shock absorbing portion that is located outward in the vehicle width direction of a fastening portion has a lower rigidity than a part of the shock absorbing portion that is located inward in the vehicle width direction of the fastening portion, the fastening portion being a portion where the battery is fastened to the rocker.

2. The vehicle lower part structure according to claim 1, wherein the shock absorbing portion includes an outer shock absorbing portion located in an outer side in the vehicle width direction of the rocker, and an inner shock absorbing portion located inward in the vehicle width direction of the outer shock absorbing portion.

3. The vehicle lower part structure according to claim 2, wherein the outer shock absorbing portion and the inner shock absorbing portion are provided as a single-piece member.

4. The vehicle lower part structure according to claim 1, wherein the shock absorbing portion is composed of a plurality of members having different rigidities, and the members are integrated by being coupled to each other.

5. The vehicle lower part structure according to claim 1, wherein the fastening portion is located on a lower wall of the rocker.
